(19) United States
(12) Patent Application Publication
(10) Pub. No.: US 2025/0346138 A1
(43) Pub. Date: Nov. 13, 2025

(54) CHARGING ROBOT CONTROL APPARATUS AND CONTROL METHOD THEREOF

(71) Applicants: HYUNDAI MOTOR COMPANY, Seoul (KR); Kia Corporation, Seoul (KR)

(72) Inventors: Hwa Woong YOO, Hwaseong-si (KR); Ki Hoon NAM, Hwaseong-si (KR); Ji Su KIM, Hwaseong-si (KR); Byung Ho YOON, Hwaseong-si (KR); Yong Chul SHIN, Hwaseong-si (KR)

(21) Appl. No.: 18/930,743

(22) Filed: Oct. 29, 2024

(30) Foreign Application Priority Data
May 9, 2024 (KR) 10-2024-0061278

(51) Int. Cl. B60L 53/37; B60L 53/31; B60L 53/62

(52) U.S. Cl. CPC B60L 53/37; B60L 53/31; B60L 53/62

(57) ABSTRACT

A charging robot control apparatus can include a memory storing computer-executable instructions and at least one processor that accesses the memory and executes the instructions. The at least one processor determines a parking state of a target vehicle by means of a vehicle type of the target vehicle and a parking position of the target vehicle, based on identifying the target vehicle, controls a charging robot to charge the target vehicle, based on determination that the parking state is a state in which the charging robot is able to charge the target vehicle, and controls the charging robot to disconnect a connection between a charger and the target vehicle, based on a state of charge (SOC) of the target vehicle.

### CROSS-REFERENCE TO RELATED APPLICATION

This application claims the benefit of priority to Korean Patent Application No. 10-2024-0061278, filed in the Korean Intellectual Property Office on May 9, 2024, the entire contents of which are incorporated herein by reference.

### TECHNICAL FIELD

The present disclosure relates to a charging robot control apparatus and a control method thereof, and more particularly, relates to technologies for controlling a charging robot configured to charge an electric vehicle.

### BACKGROUND

The demand for electric vehicles is increasing rapidly due to growing concerns over environmental pollution caused by vehicle emissions and the rising costs of diesel and gasoline, which serve as fuel for conventional vehicles. With this increase in demand, there is also a corresponding rise in interest in electric vehicle charging robots. Robots are widely used in various fields, driven by advancements in control technology. Examples include surgical robots, housekeeper robots, service robots, aerospace remote robots, and hazardous materials handling robots. Specifically, a service robot may include a charging robot designed for charging electric vehicles.

However, charging robots currently face several challenges, including performing the tasks of recognizing electric vehicles, coupling a charging cable to a charging port to charge the electric vehicle, and decoupling the charging cable coupled to the electric vehicle. These operations may suffer from malfunctions or errors, which present significant drawbacks in the electric vehicle charging process and can negatively impact consumer demand for electric vehicles.

To address these issues, there is a growing need for advanced technology that enables charging robots to accurately verify the parking state of electric vehicles and automatically manage the charging process.

### SUMMARY

The present disclosure is directed to a charging robot control apparatus and a control method thereof.

The present disclosure is directed to a charging robot control apparatus for determining a parking state of a target vehicle by means of a vehicle type of the target vehicle and a parking position of the target vehicle, based on identifying the target vehicle, to provide a user with an unmanned parking and charging system based on an autonomous parking function and a control method thereof.

The present disclosure is also directed to a charging robot control apparatus for allowing a charging robot to charge a target vehicle, based on determination that a parking state is a state in which the charging robot is able to charge the target vehicle, to provide a user with a function in which the driver or the user automatically proceeds with charging the vehicle without alighting from the vehicle and a control method thereof.

The present disclosure is also directed to a charging robot control apparatus for applying a predetermined offset to a relative position of a charging port to determine a position of a robot arm of a charging robot to increase the stability of the charging robot, while performing an operation of moving the charging robot and an operation of charging the vehicle, and a control method thereof.

According to an aspect of the present disclosure, a charging robot control apparatus can include a memory storing computer-executable instructions, a communication device that assists in communicating with a server, and at least one processor that accesses the memory and executes the instructions. The at least one processor can determine a parking state of a target vehicle by means of a vehicle type of the target vehicle and a parking position of the target vehicle, based on identifying the target vehicle, can control a charging robot to charge the target vehicle, based on determination that the parking state is a state in which the charging robot is able to charge the target vehicle, and can control the charging robot to disconnect a connection between a charger and the target vehicle, based on a state of charge (SOC) of the target vehicle.

In some implementations, the at least one processor can receive a closed-circuit television (CCTV) image capable of recognizing a target vehicle number, from a CCTV camera installed at a position spaced apart from a position of the charging robot at a predetermined distance, and identify the target vehicle among at least one vehicle included in the CCTV image.

In some implementations, the at least one processor can receive a parking position of the target vehicle, the parking position being determined by a light detection and ranging (LiDAR) sensor of a safety pillar module installed at a position spaced apart from a position of the CCTV camera at a predetermined distance, from the safety pillar module, and can determine a parking angle of the target vehicle and a parking distance between the target vehicle and the safety pillar module, the parking angle and the parking distance being for determining the parking state of the target vehicle, based on the position of the safety pillar module and the parking position of the target vehicle.

In some implementations, the at least one processor can determine whether the parking angle is included in a reference angle range including an angle range in which the charging robot is able to charge the target vehicle, may determine whether the parking distance is included in a reference distance range including a distance range in which the charging robot is able to charge the target vehicle, and can determine that the parking state is the state in which the charging robot is able to charge the target vehicle, based on that the parking angle is included in the reference angle range and the parking distance is included in the reference distance range.

In some implementations, the at least one processor can provide a driver with a notification to park the target vehicle again, via an output device of the safety pillar module, based on that the parking angle is not included in the reference angle range and the parking distance is not included in the reference distance range.

In some implementations, the at least one processor can receive information about an end point of a side of the target vehicle, the end point at which the target vehicle and the safety pillar module are adjacent to each other, from the safety pillar module, can determine a position of the end point, based on an angle and a distance formed by the end point and the position of the safety pillar module, can apply the vehicle type of the target vehicle to a database to receive an absolute position of a charging port of the target vehicle, and can determine a relative position of the charging port with respect to the charging robot, based on the position of the end point and the absolute position of the charging port.

In some implementations, the at least one processor can control the charging robot to move to a position of the charger, based on determination that the parking state is the state in which the charging robot is able to charge the target vehicle.

In some implementations, the at least one processor can determine whether the charging robot and a charger cable of the charger are coupled to each other, by means of comparison between an input signal of a tool changer of the charging robot and a value of a force-torque (FT) sensor of the charging robot, based on that the charging robot moves to the position of the charger, and can control the charging robot to couple the charging robot to the charger cable of the charger a predetermined number of times, based on that it fails to couple the charging robot to the charger cable of the charger.

In some implementations, the at least one processor can control the charging robot to move to a target position obtained on the basis of a stroke in which motion of the charging robot to which the charger cable is coupled is drivable, based on that it succeeds in coupling the charging robot to the charger cable of the charger.

In some implementations, the at least one processor can recognize the charging port by means of a vision camera of the charging robot, based on that the charging robot moves to the target position along a rail, can apply a predetermined offset to the relative position of the charging port to determine a position of a robot arm of the charging robot, can control the charging robot to charge the target vehicle based on the position of the robot arm, and can provide a driver to a notification to park the target vehicle again, via an output device of the safety pillar module, based on that the charging port is not recognized.

According to another aspect of the present disclosure, a charging robot control method can include determining a parking state of a target vehicle by means of a vehicle type of the target vehicle and a parking position of the target vehicle, based on identifying the target vehicle, controlling a charging robot to charge the target vehicle, based on determination that the parking state is a state in which the charging robot is able to charge the target vehicle, and controlling the charging robot to disconnect a connection between a charger and the target vehicle, based on a state of charge (SOC) of the target vehicle.

In some implementations, the determining of the parking state of the target vehicle can include receiving a closed-circuit television (CCTV) image capable of recognizing a target vehicle number, from a CCTV camera installed at a position spaced apart from a position of the charging robot at a predetermined distance, and identifying the target vehicle among at least one vehicle included in the CCTV image.

In some implementations, the determining of the parking state of the target vehicle can include receiving a parking position of the target vehicle, the parking position being determined by a light detection and ranging (LiDAR) sensor of a safety pillar module installed at a position spaced apart from a position of the CCTV camera at a predetermined distance, from the safety pillar module, and determining a parking angle of the target vehicle and a parking distance between the target vehicle and the safety pillar module, the parking angle and the parking distance being for determining the parking state of the target vehicle, based on the position of the safety pillar module and the parking position of the target vehicle.

In some implementations, the determining of the parking state of the target vehicle can include determining whether the parking angle is included in a reference angle range including an angle range in which the charging robot is able to charge the target vehicle, determining whether the parking distance is included in a reference distance range including a distance range in which the charging robot is able to charge the target vehicle, and determining that the parking state is the state in which the charging robot is able to charge the target vehicle, based on that the parking angle is included in the reference angle range and the parking distance is included in the reference distance range.

In some implementations, the determining of the parking state of the target vehicle can include providing a driver with a notification to park the target vehicle again, via an output device of the safety pillar module, based on that the parking angle is not included in the reference angle range and the parking distance is not included in the reference distance range.

In some implementations, the determining of the parking state of the target vehicle can include receiving information about an end point of a side of the target vehicle, the end point at which the target vehicle and the safety pillar module are adjacent to each other, from the safety pillar module, determining a position of the end point, based on an angle and a distance formed by the end point and the position of the safety pillar module, applying the vehicle type of the target vehicle to a database to receive an absolute position of a charging port of the target vehicle, and determining a relative position of the charging port with respect to the charging robot, based on the position of the end point and the absolute position of the charging port.

In some implementations, the controlling of the charging robot to charge the target vehicle can include controlling the charging robot to move to a position of the charger, based on determination that the parking state is the state in which the charging robot is able to charge the target vehicle.

In some implementations, the controlling of the charging robot to charge the target vehicle can include determining whether the charging robot and a charger cable of the charger are coupled to each other, by means of comparison between an input signal of a tool changer of the charging robot and a value of a force-torque (FT) sensor of the charging robot, based on that the charging robot moves to the position of the charger, and controlling the charging robot to couple the charging robot to the charger cable of the charger a predetermined number of times, based on that it fails to couple the charging robot to the charger cable of the charger.

In some implementations, the controlling of the charging robot to charge the target vehicle can include controlling the charging robot to move to a target position obtained on the basis of a stroke in which motion of the charging robot to which the charger cable is coupled is drivable, based on that it succeeds in coupling the charging robot to the charger cable of the charger.

In some implementations, the controlling of the charging robot to charge the target vehicle can include recognizing the charging port by means of a vision camera of the charging robot, based on that the charging robot moves to the target position along a rail, applying a predetermined offset to the relative position of the charging port to determine a position of a robot arm of the charging robot, controlling the charging robot to charge the target vehicle based on the position of the robot arm, and providing a driver to a notification to park the target vehicle again, via an output device of the safety pillar module, based on that the charging port is not recognized.

### BRIEF DESCRIPTION OF THE DRAWINGS

FIG. 1 is a diagram illustrating an example of a charging robot control apparatus.

FIG. 2 is a flowchart for describing an example of a charging robot control method.

FIG. 3 is a diagram illustrating an example of a connection between an external device and a charging robot control apparatus.

FIG. 4 is a flowchart for describing an example of a method for controlling a charging robot.

FIG. 5 is a diagram illustrating an example of a method for determining a parking state of a target vehicle.

FIG. 6 is a diagram illustrating an example of a method for determining a relative position of a charging port of a target vehicle.

FIG. 7 is a diagram illustrating an example of a method for determining a position of a robot arm of a charging robot.

FIG. 8 is a diagram drawing illustrating an example of a method for determining whether a charging robot and a charger cable are coupled to each other.

FIG. 9 is a diagram illustrating an example of a computing system associated with a charging robot control apparatus or a charging robot control method.

### DETAILED DESCRIPTION

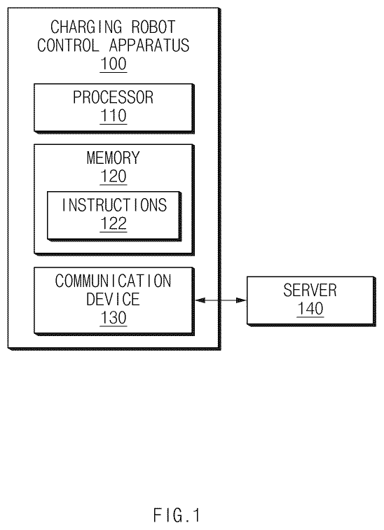

Hereinafter, the present disclosure will be described in detail with reference to FIGS. 1 to 9.

FIG. 1 is a diagram illustrating an example of a charging robot control apparatus.

A charging robot control apparatus 100 can include a processor 110, a memory 120 storing instructions, and a communication device 130.

The charging robot control apparatus 100 can refer to an apparatus configured to control a charging robot. For example, the charging robot control apparatus 100 can control a rail-type mobile charging robot to charge a vehicle. Specifically, the charging robot control apparatus 100 can communicate with the charging robot, a closed-circuit television (CCTV) camera, and a safety pillar module via the communication device 130 to thereby charge the vehicle. The charging robot control apparatus 100 can communicate with the above-mentioned external devices (e.g., the charging robot, the CCTV camera, and the safety pillar module) to determine a parking state of the vehicle and determine a position of a charging port of the vehicle.

In some implementations, the charging robot control apparatus 100 can determine the position of the charging port to determine an optimal position of the charging robot for charging the vehicle. Furthermore, the charging robot control apparatus 100 can use a tool changer of the charging robot to charge at least one vehicle with at least one charger.

The charging robot control apparatus 100 can control the charging robot to perform the operations. For example, the charging robot control apparatus 100 can apply a diagonal parking scheme near a rail on which the charging robot is located to charge at least one vehicle, ensuring convenient charging for vehicle users. Furthermore, the charging robot control apparatus 100 can use external devices to control the charging robot for charging the vehicle, reducing calculation necessary for an operation (i.e., the amount of calculation of the processor 110). In addition, the charging robot control apparatus 100 can determine an optimal position for the charging robot to reduce the risk of an accident during the vehicle charging process.

The processor 110 can execute software and can control at least one component (e.g., a hardware or software component) connected to the processor 110. In some implementations, the processor 110 can perform a variety of data processing or calculation. For example, the processor 110 can execute all operations performed by the charging robot control apparatus 100. Therefore, for simplicity in this specification, the operations performed by the charging robot control apparatus 100 are primarily described as being executed by the processor 110.

Furthermore, for simplicity in this specification, the processor 110 is mainly described as, but not limited to, one processor. For example, the charging robot control apparatus 100 can include at least one processor. Each of the at least one processor can execute all operations associated with an operation of controlling the charging robot.

The memory 120 can temporarily and/or permanently store various pieces of data and/or information required to control the charging robot.

The communication device 130 can be configured to perform communication between the charging robot control apparatus 100 and an external device or a server 140. For example, the communication device 130 can include one or more components for performing communication between the charging robot control apparatus 100 and the external device or the server 140. For example, the communication device 130 can include a short range wireless communication unit, a microphone, or the like. A short range communication technology may be, but is not limited to, a wireless LAN (WI-FI), BLUETOOTH, ZIGBEE, Wi-Fi Direct (WFD), ultra-wideband (UWB), infrared data association (IrDA), Bluetooth low energy (BLE), near field communication (NFC), or the like.

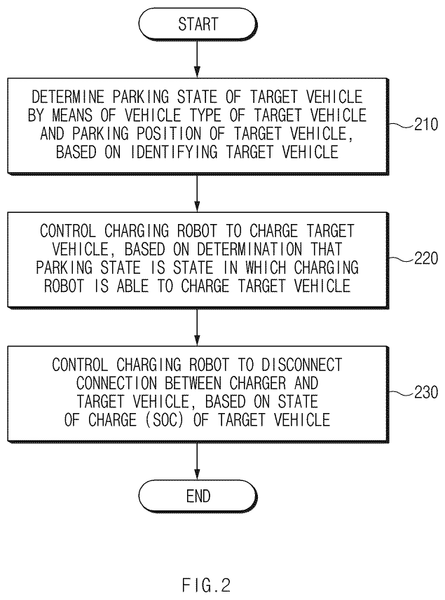

FIG. 2 is a flowchart for describing an example of a charging robot control method.

In operation 210, a charging robot control apparatus (e.g., a charging robot control apparatus 100 of FIG. 1) can determine, based on a target vehicle being identified, a parking state of the target vehicle according toa vehicle type of the target vehicle and a parking position of the target vehicle. For example, the target vehicle can indicate a vehicle scheduled to be charged by the charging robot control apparatus among vehicles parked in a parking area in which the charging robot is located.

The charging robot control apparatus can identify the vehicle type and the parking position of the target vehicle scheduled to be charged. The charging robot control apparatus can identify the vehicle type of the target vehicle to thereby identify a position of a charging port of the target vehicle. The charging robot control apparatus can identify the parking position of the target vehicle to thereby identify a position to move the charging robot.

The charging robot control apparatus can determine the parking state of the target vehicle to thereby control the charging robot to charge the target vehicle. In some implementations, the parking state can include a state in which the charging robot can charge the target vehicle.

In operation 220, the charging robot control apparatus can control the charging robot to charge the target vehicle, based on a determination that the parking state is the state in which the charging robot can charge the target vehicle. In some implementations, the charging robot can be located on a movable rail. The charging robot can move in a predetermined direction on the movable rail.

The movable rail can be provided at a position adjacent to parking spaces of vehicles. The charging robot control apparatus can control the charging robot to move on the rail. However, the method for moving the charging robot is not limited thereto. For example, the charging robot may be located on the movable rail but detach from the movable rail and control its drive motor to move independently.

In operation 230, the charging robot control apparatus can be configured to, based on the state of charge (SOC) of the target vehicle, control the charging robot to disconnect a connection between the charger and the target vehicle. For example, when the SOC of the target vehicle is a state in which the battery of the target vehicle reaches a predetermined amount of charge (e.g., an amount of charge input by a user or a driver), the charging robot control apparatus can control the charging robot to disconnect the connection between the charger and the target vehicle.

When the charging robot disconnects the connection between the charger and the target vehicle, the charging robot control apparatus can control a tool changer of the charging robot to decouple a charger cable from the charging robot. Thereafter, the charging robot control apparatus can control the charging robot to move to a predetermined waiting position.

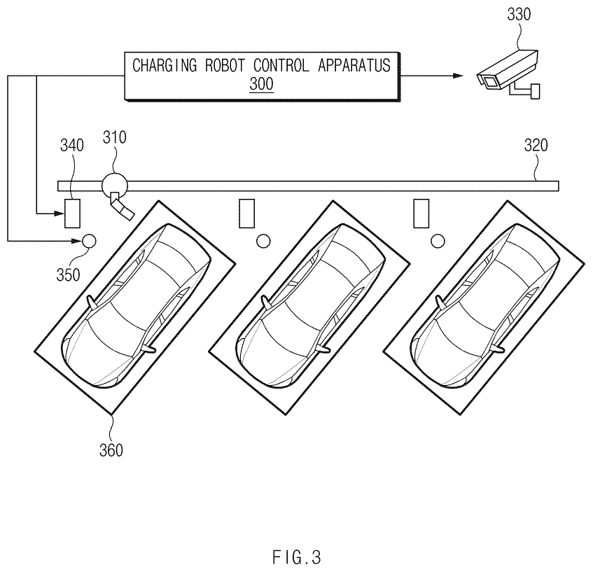

FIG. 3 is a diagram illustrating a connection between an external device and a charging robot control apparatus.

A charging robot control apparatus 300 can be connected to a charging robot 310 located on a movable rail 320, a CCTV camera 330, a charger 340, and a safety pillar module 350. For example, the charging robot control apparatus 300 can control the charging robot 310 to charge a target vehicle 360, through an operation of each of the charging robot 310, the CCTV camera 330, the charger 340, or the safety pillar module 350, which will be described below. Therefore, for convenience of description in the specification, each of the operations to be described below is described as also operating by the charging robot control apparatus 300.

The charging robot 310 can refer to a robot capable of controlling motion of a robot arm and its position on the rail 320 and charging the target vehicle 360. The charging robot 310 can communicate with the CCTV camera 330, the charger 340, and the safety pillar module 350, using wired and wireless communication.

The charging robot 310 can include a tool changer and can mount and/or demount a charger cable using the tool changer. The tool changer can include a sensor configured to notify whether a tool is mounted. Furthermore, the charging robot 310 can include a torque sensor capable of measuring torque at a robot arm end. After mounting the charger cable on the tool changer, the charging robot 310 can charge the target vehicle 360. Thereafter, when the charging starts, the charging robot 310 can disconnect the connection with the charger cable mounted on the tool changer and can move to an initial position or a waiting position.

The CCTV camera 330 (e.g., a CCTV vision module) can determine whether the target vehicle 360 is parked in a detectable parking area and can recognize a vehicle number. The recognized vehicle number can interwork with a server database to provide vehicle information inquiry. The charging robot control apparatus 300 can receive a CCTV image capable of recognizing a target vehicle number, from the CCTV camera 330 installed at a position spaced apart from the position of the charging robot 310 at a predetermined distance. The charging robot control apparatus 300 can identify the target vehicle 360 among at least one vehicle (e.g., vehicles shown in FIG. 3) included in the CCTV image.

In some implementations, the charger 340 can be installed at relatively the same position as a parking area in which the target vehicle 360 is parked.

The safety pillar module 350 can be coupled and installed at one portion of the parking area in which the charging robot 310 can perform charging. In some implementations, the safety pillar module 350 can include a displacement sensor or LiDAR sensor, which is capable of measuring a distance spaced apart from an object. The displacement sensor or the LiDAR sensor can measure a position (e.g., an angle and a distance) of an object at a spaced position. The safety pillar module 350 can include a display and a speaker, which are capable of providing information to a user and/or a driver.

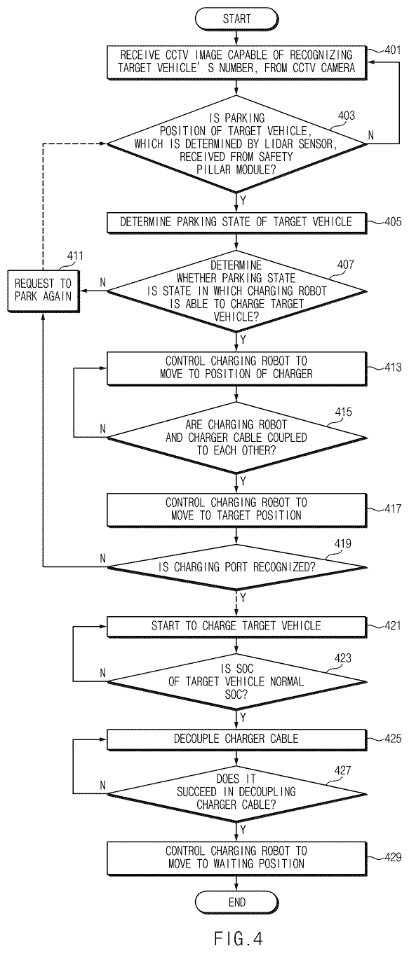

FIG. 4 is a flowchart for describing an example of a method for controlling a charging robot.

In operation 401, a charging robot control apparatus (e.g., a charging robot control apparatus 300 of FIG. 3) can receive, from a CCTV camera, a CCTV image for recognizing a target vehicle number. The charging robot control apparatus can identify, from the CCTV image, a parking position (e.g., parking area 1, parking area 2, or parking area 3) of the entered target vehicle. The charging robot control apparatus can recognize a vehicle license plate from the CCTV image and can identify vehicle information (e.g., a vehicle type).

In operation 403, the charging robot control apparatus can receive a parking position of the target vehicle, which is determined by a LiDAR sensor, from a safety pillar module. For example, the charging robot control apparatus can determine whether the target vehicle parked in a parking area identified from the CCTV image is parked, based on the safety pillar module. Specifically, the charging robot control apparatus can determine whether the target vehicle parked in the parking area is parked, based on a displacement sensor, a LiDAR sensor, and/or the like included in the safety pillar module. For example, when the parking position is not received, the charging robot control apparatus can perform operation 401.

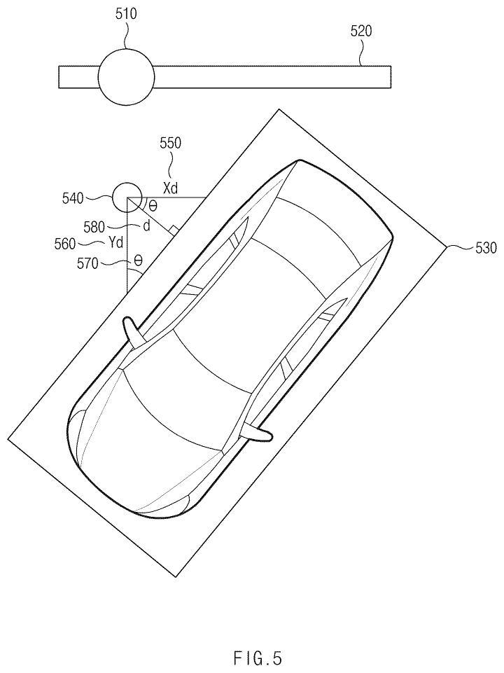

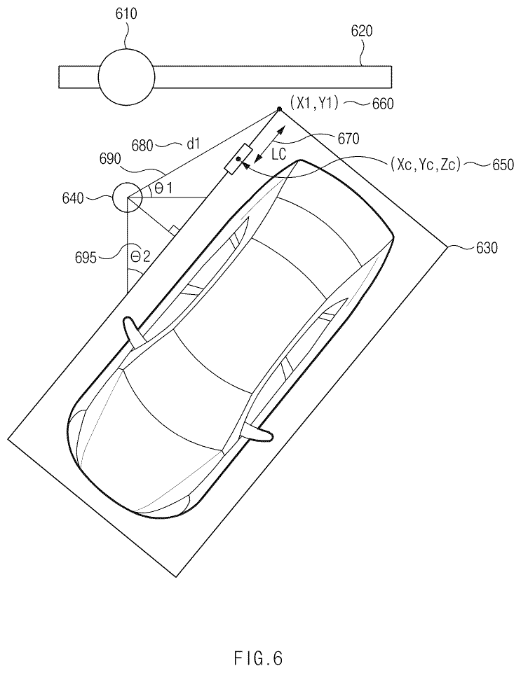

In operation 405, the charging robot control apparatus can determine a parking state of the target vehicle, based on the parking position of the target vehicle being received. In some implementations, the charging robot control apparatus can identify a parking angle of the target vehicle and a parking distance between the safety pillar module and the target vehicle to determine the parking state of the target vehicle. Furthermore, the charging robot control apparatus can identify a position of a charging port of the target vehicle, based on the vehicle type identified from the CCTV image. A detailed method for determining the parking state of the target vehicle will be described below with reference to FIGS. 5 and 6.

In operation 407, the charging robot control apparatus can determine whether the parking state is a state in which the charging robot is able to charge the target vehicle. For example, the charging robot control apparatus can determine the parking state of the vehicle, based on the parking angle of the target vehicle and the parking distance of the target vehicle. In some implementations, the parking angle can be used to determine if it is suitable for charging the vehicle using the charging robot. The parking distance can be used to determine if it is suitable to charge the vehicle using the charging robot.

In operation 411, the charging robot control apparatus can request to park again, based on the parking state not being the state in which the charging robot is able to charge the target vehicle. In some implementations, the charging robot control apparatus can request a driver to park again using a display or a speaker of the safety pillar module.

In operation 413, the charging robot control apparatus can control the charging robot to move to a position of a charger, based on the parking state being the state in which the charging robot is able to charge the target vehicle. When the charging robot moves to the position of the charger, the charging robot control apparatus can control the charging robot to couple the charging robot to a charger cable.

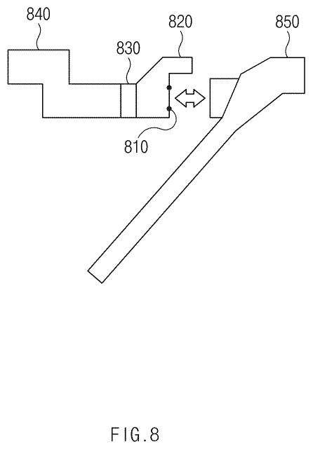

In operation 415, the charging robot control apparatus can determine whether the charging robot and the charger cable are coupled to each other. For example, the charging robot control apparatus can determine, based on a tool changer of the charging robot, whether the charging robot and the charger cable are coupled to each other. For example, the charging robot control apparatus can check an input signal of the tool changer and a value of a force-torque (FT) sensor to determine whether the charger cable is mounted. When it fails to mount the charger cable, the charging robot control apparatus can reattempt to mount the charger cable a predetermined number of times and can transmit information about occurrence of an error to a user and/or a driver. A detailed description of determining whether the charging robot and the charger cable are coupled to each other based on the tool changer will be described below with reference to FIG. 8.

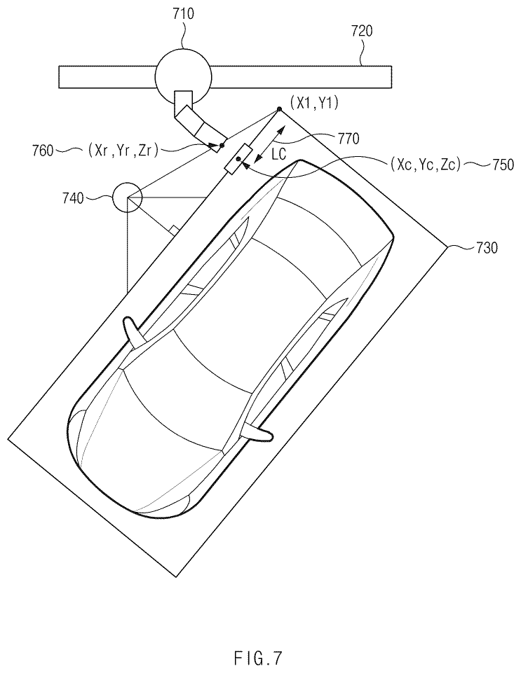

When the charging robot and the charger cable are coupled to each other, in operation 417, the charging robot control apparatus can control the charging robot to move to a target position. The target position can refer to a calculated position at which the charging robot is able to recognize a charging port of the target vehicle. A detailed description associated with the target position will be described below with reference to FIG. 7.

In operation 419, the charging robot control apparatus can determine whether the charging robot recognizes the charging port of the target vehicle. In some implementations, the charging robot can recognize the charging port based on a vision camera of the charging robot. When the charging robot fails to recognize the charging port, the charging robot control apparatus can transmit a request to park the vehicle again to the driver.

In operation 421, the charging robot control apparatus can start charging the target vehicle. For example, when the charging robot recognizes the charging port, the charging robot control apparatus can control the charging robot to start charging the target vehicle.

In operation 423, the charging robot control apparatus can determine whether an SOC of the target vehicle is a normal SOC. For example, the normal SOC can be determined by whether the battery of the target vehicle meets an amount of charge determined by the driver. When the battery of the target vehicle does not meet the amount of charge, the charging robot control apparatus can repeatedly charge the target vehicle.

In operation 425, the charging robot control apparatus can control the charging robot to decouple the charger cable coupled to the charging robot. In some implementations, the charging robot control apparatus can control the tool changer of the charging robot, based on the SOC of the target vehicle being determined as the normal SOC, to decouple the charger cable coupled to the charging robot.

In operation 427, the charging robot control apparatus can determine whether it succeeds in decoupling the charger cable. In some implementations, the charging robot control apparatus can compare an input signal of the tool changer of the charging robot with a value of the FT sensor to determine whether to decouple the charger cable. A detailed description of determining whether the charging robot and the charger cable are decoupled from each other based on the tool changer will be described below with reference to FIG. 8.

In operation 429, the charging robot control apparatus can control the charging robot to move to a waiting position, based on the charging robot succeeding in decoupling the charger cable. The waiting position can refer to a position predetermined by the user.

FIG. 5 is a diagram illustrating an example of a method for determining a parking state of a target vehicle.

A charging robot control apparatus (e.g., a charging robot control apparatus 300 of FIG. 3) can determine a parking state of a target vehicle 530. For example, the charging robot control apparatus can primarily determine the parking state of the target vehicle 530 such that a charging robot 510 located on a movable rail 520 charges the target vehicle 530 (i.e., such that the charging robot 510 determines to start charging the target vehicle 530). The charging robot control apparatus can determine a parking angle 570 and a parking distance 580 to determine the parking state of the target vehicle 530.

The charging robot control apparatus can receive, from the safety pillar module 540, a parking position of the target vehicle 530, which is determined by a LiDAR sensor of a safety pillar module 540 installed at a position spaced apart from the position of a CCTV camera at a predetermined distance.

The charging robot control apparatus can determine, based on the position of the safety pillar module 540 and the parking position of the target vehicle 530, the parking angle 570 of the target vehicle 530 and the parking distance 580 between the target vehicle 530 and the safety pillar module 540, to thereby determine the parking state of the target vehicle 530.

In some implementations, to determine the parking angle 570 and the parking distance 580, the charging robot control apparatus can determine a plane in a three-dimensional (3D) space including the charging robot 510, the target vehicle 530, and the safety pillar module 540 as a two-dimensional (2D) coordinate system. For example, the 2D coordinate system can refer to a coordinate system in which the position of the safety pillar module 540 servers as the origin (or a reference point).

The charging robot control apparatus can obtain a first distance 550 and a second distance 560, which are formed by the target vehicle 530 and the safety pillar module 540, to determine the parking angle 570. For example, the first distance 550 may indicate a distance to a side adjacent to the charging robot 510 among sides of the target vehicle 530 from the safety pillar module 540. The second distance 560 may indicate a distance to a side away from the charging robot 510 among the sides of the target vehicle 530 from the safety pillar module 540. The charging robot control apparatus can apply the first distance 550 and the second distance 560 to Equation 1 below to determine the parking angle 570.

$$θ = {tan}^{- 1} \frac{{x}_{d}}{{y}_{d}} \qquad [ Equation 1 ]$$

Herein, x_{d} can refer to the first distance 550, y_{d} can refer to the second distance 560, and θ can refer to the parking angle 570.

The charging robot control apparatus can apply the first distance 550 and the parking angle 570 to Equation 2 below to determine the parking distance 580.

$$d = {x}_{d} cos θ \qquad [ Equation 2 ]$$

Herein, x_{d} can refer to the first distance 550, θ can refer to the parking angle 570, and d can refer to the parking distance 580.

The charging robot control apparatus can determine whether the parking angle 570 is within a reference angle range including an angle range in which the charging robot 510 is able to charge the target vehicle 530. The charging robot control apparatus can determine whether the parking distance 580 is within a reference distance range including a distance range in which the charging robot 510 is able to charge the target vehicle 530. In some implementations, the reference angle range and the reference distance range can include predetermined values by information of the target vehicle 530 and a mechanical stroke of the charging robot 510.

The charging robot control apparatus can determine, based on a determination that the parking angle 570 is within the reference angle range and the parking distance 580 is within the reference distance range, a parking state as a state in which the charging robot 510 is able to charge the target vehicle 530.

In some implementations, the charging robot control apparatus can provide a driver with a notification (i.e., a re-parking notification) to park the target vehicle 530 again, via an output device of the safety pillar module 540, based on a determination that the parking angle 570 is not within the reference angle range or the parking distance 580 is not within the reference distance range.

FIG. 6 is a diagram illustrating an example of a method for determining a relative position of a charging port of a target vehicle.

A charging robot control apparatus (e.g., a charging robot control apparatus 300 of FIG. 3) can determine a relative position 650 of a charging port of a target vehicle 630. For example, the charging robot control apparatus can determine the relative position 650 of the charging port, such that a charging robot 610 located on a movable rail 620 charges the target vehicle 630 (i.e., such that the charging robot 610 couples a charger cable to the target vehicle 630). The charging robot control apparatus can determine a target distance 680, a position 660 of an end point, a first angle 690, and a second angle 695 to determine the relative position 650 of the charging port.

In some implementations, to determine the relative position 650, the charging robot control apparatus can determine a 3D space including the charging robot 610, the target vehicle 630, and a safety pillar module 640 as a 3D coordinate system. For example, the 3D coordinate system can refer to a coordinate system in which the position of the safety pillar module 640 serves as the origin (or a reference point).

The charging robot control apparatus can receive information about an end point of a side of the target vehicle 630, at which the target vehicle 630 and the safety pillar module 640 are adjacent to each other. The charging robot control apparatus can determine the position 660 of the end point, based on the target distance 680 and the first angle 690, which are formed by the information about the end point and the position of the safety pillar module 640. For example, the charging robot control apparatus can apply the target distance 680 and the first angle 690 to Equation 3 below to determine the position 660 of the end point.

$$( {x}_{1} , {y}_{1} ) = ( {d}_{1} cos {θ}_{1} , {d}_{1} sin {θ}_{1} ) \qquad [ Equation 3 ]$$

Herein, d₁ can refer to the target distance 680, θ₁ can refer to the first angle 690, and (x₁,y₁) can refer to the position 660 of the end point.

The charging robot control apparatus can apply a vehicle type of the target vehicle 630 to a database to receive an absolute position of the charging port of the target vehicle 630. For example, assuming that the side at which the charging port is located in the target vehicle 630 is a 2D plane, which is previously stored in the database, the absolute position of the charging port can refer to 2D coordinates of the charging port. The charging robot control apparatus can determine the relative position 650 of the charging port with respect to the charging robot 610, based on the position 660 of the end point and the absolute position of the charging port. For example, the charging robot control apparatus can apply the absolute position of the charging port, the position 660 of the end point, and the second angle 695 to Equation 4 below to determine the relative position 650 of the charging port.

$$( {x}_{c} , {y}_{c} , {z}_{c} ) = ( {x}_{1} - {L}_{c} sin {θ}_{2} , {y}_{1} - {L}_{c} cos {θ}_{2} , {z}_{c} ) \qquad [ Equation 4 ]$$

Herein, L_{c} and z_{c} can refer to the absolute positions of the charging port, θ₂ can refer to the second angle 695, and (x_{c}, y_{c}, z_{c}) can refer to the relative position 650 of the charging port.

FIG. 7 is a diagram illustrating an example of a method for determining a position of a robot arm of a charging robot.

A charging robot control apparatus (e.g., a charging robot control apparatus 300 of FIG. 3) can determine a position 760 of a robot arm of a charging robot 710. For example, the charging robot control apparatus can determine the position 760 of the robot arm, such that the charging robot 710 located on a movable rail 720 charges a target vehicle 730 (i.e., such that the charging robot 710 places the robot arm on the charging port of the target vehicle 730).

In some implementations, to determine the position 760 of the robot arm, the charging robot control apparatus can determine a 3D space including the charging robot 710, the target vehicle 730, and a safety pillar module 740 as a 3D coordinate system. For example, the 3D coordinate system can refer to a coordinate system in which the position of the safety pillar module 740 serves as the origin (or a reference point).

The charging robot control apparatus can control the charging robot 710 to move to a target position obtained on the basis of a stroke in which motion of the charging robot 710 to which a charger cable is coupled is drivable, based on a determination of whether the charger cable of a charger is coupled. For example, the target position can be determined by Equation 5 below.

$${x}_{rail} = {x}_{r} + {x}_{stroke} \qquad [ Equation 5 ]$$

Herein, xᵣ can refer to the component of the x-coordinate at the position 760 of the robot arm, xₛₜᵣₒₖₑ can refer to the range of the stroke in which the motion of the charging robot 710 is drivable, and xᵣₐᵢₗ can refer to the target position at which the charging robot 710 located on the rail 720 will be located.

The charging robot control apparatus can, based on the charging robot 710 being moved to the target position along the rail 720, recognize the charging port using a vision camera of the charging robot 710. The charging robot control apparatus can apply a predetermined offset to a relative position 750 of the charging port to determine the position 760 of the robot arm of the charging robot 710. For example, the position 760 of the robot arm may be determined by Equation 6 below.

$$( {x}_{r} , {y}_{r} , {z}_{r} ) = ( {x}_{c} + {x}_{offset} , {y}_{c} + {y}_{offset} , {z}_{c} + {z}_{offset} ) \qquad [ Equation 6 ]$$

Herein, (x_{c}, y_{c}, z_{c}) can refer to the relative position 750 of the charging port, (x_{offset}, y_{offset}, z_{offset}) can refer to the predetermined offset, and (xᵣ, yᵣ, zᵣ) can refer to the position 760 of the robot arm.

The charging robot control apparatus can control the charging robot 710 to charge the target vehicle 730 based on the position 760 of the robot arm. In some implementations, the charging robot control apparatus can provide a driver with a notification to park the target vehicle 730 again, via an output device of the safety pillar module 740, based on that the charging port is not recognized.

FIG. 8 is a diagram illustrating an example of a method for determining whether a charging robot and a charger cable are coupled to each other.

A charging robot control apparatus (e.g., a charging robot control apparatus 300 of FIG. 3) can control a charging robot to move to a position of a charger, based on a determination that a parking state of a target vehicle is a state in which the charging robot is able to charge the target vehicle.

The charging robot control apparatus can, based on the charging robot reaching the position of the charger, determine whether the charging robot and a charger cable of the charger are coupled to each other according to comparison between an input signal of a tool changer 820 of the charging robot and a value of an FT sensor 830 of the charging robot. For example, the charging robot control apparatus can control the charging robot to couple the charging robot to the charger cable of the charger a predetermined number of times, based on that it fails to couple the charging robot to the charger cable of the charger.

The charging robot control apparatus can determine whether the charging robot and a charger cable 850 are coupled to each other. For example, the charging robot control apparatus can determine whether the charging robot and the charger cable 850 are coupled to each other based on the tool changer 820 of the charging robot. For example, the charging robot control apparatus can check the input signal of the tool changer 820 and the value of the FT sensor 830 to determine whether the charger cable 850 is mounted.

The charging robot control apparatus can determine whether it succeeds in decoupling the charger cable 850. In some implementations, the charging robot control apparatus can compare the input signal of the tool changer 820 with the value of the FT sensor 830 to determine whether to decouple the charger cable 850.

For example, the FT sensor 830 may be connected with an end link 840 of a robot arm. Furthermore, the input signal of the tool changer 820 may be obtained from a proximity sensor 810 mounted on the tool changer 820.

To determine whether the charging robot and the charger cable 850 are coupled to each other or determine whether it succeeds in decoupling the charger cable 850, the charging robot control apparatus can determine whether the charger cable 850 is coupled or whether it succeeds in decoupling the charger cable 850, using a torque value of the FT sensor 830 in a z-axis direction. When the torque value of the FT sensor 830 in the z-axis direction is greater than or equal to a predetermined torque value, the charging robot control apparatus can determine that the charging robot and the charger cable 850 are coupled to each other. In some implementations, when the torque value of the FT sensor 830 in the z-axis direction is less than the predetermined torque value, the charging robot control apparatus can determine that the charging robot and the charger cable 850 are decoupled from each other.

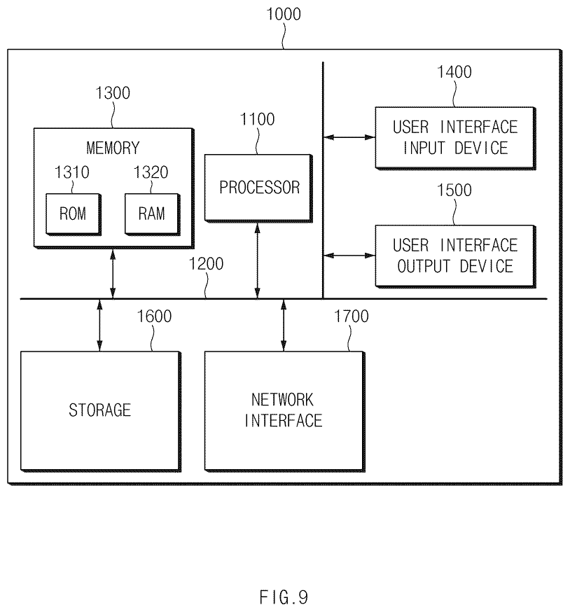

FIG. 9 is a diagram illustrating an example of a computing system associated with a charging robot control apparatus or a charging robot control method.

Referring to FIG. 9, a computing system 1000 about the charging robot control apparatus or the charging robot control method can include at least one processor 1100, a memory 1300, a user interface input device 1400, a user interface output device 1500, storage 1600, and a network interface 1700, which are connected with each other via a bus 1200.

The processor 1100 can be a central processing unit (CPU) or a semiconductor device that processes instructions stored in the memory 1300 and/or the storage 1600. The memory 1300 and the storage 1600 may include various types of volatile or non-volatile storage media. For example, the memory 1300 can include a ROM (Read Only Memory) 1310 and a RAM (Random Access Memory) 1320.

Accordingly, the operations of the method or algorithm described in connection with the implementations disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 can read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The above-described implementations can be implemented with hardware components, software components, and/or a combination of hardware components and software components. For example, the devices, methods, and components described in the embodiments may be implemented using general-use computers or special-purpose computers, such as a processor, a controller, an arithmetic logic unit (ALU), a digital signal processor, a microcomputer, a field programmable array (FPGA), a programmable logic unit (PLU), a microprocessor, or any device which may execute instructions and respond. A processing unit can perform an operating system (OS) or a software application running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit can include a plurality of processors or one processor and one controller. Also, the processing unit may have a different processing configuration, such as a parallel processor.

Software can include computer programs, codes, instructions or one or more combinations thereof and may configure a processing unit to operate in a desired manner or can independently or collectively instruct the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected over networks and be stored or executed in a dispersion manner. Software and data may be recorded in one computer-readable storage media.

The methods described above can be implemented in the form of program instructions which may be executed through various computer means and may be recorded in computer-readable media. The computer-readable media may include program instructions, data files, data structures, and the like alone or in combination, and the program instructions recorded on the media may be specially designed and configured for an example or may be known and usable to those skilled in the art of computer software. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter.

The above-described hardware devices may be configured to act as one or a plurality of software modules to perform the operations of the implementations, or vice versa.

According to at least one of implementations of the present disclosure, the charging robot control apparatus can determine a parking state of a target vehicle using a vehicle type of the target vehicle and a parking position of the target vehicle, based on identifying the target vehicle, thus providing a user with an unmanned parking and charging system based on an autonomous parking function.

Furthermore, according to at least one of implementations of the present disclosure, the charging robot control apparatus can allow a charging robot to charge the target vehicle, based on a determination that the parking state is a state in which the charging robot is able to charge the target vehicle, thus providing the user with a function in which the driver or the user automatically proceeds with charging the vehicle without alighting from the vehicle.

Furthermore, according to at least one of implementations of the present disclosure, the charging robot control apparatus can apply a predetermined offset to a relative position of a charging port to determine a position of a robot arm of the charging robot, thus increasing the stability of the charging robot, while performing an operation of moving the charging robot and an operation of charging the vehicle.

What is claimed is:

1. A control apparatus for a charging robot, comprising:
a memory storing computer-executable instructions;
at least one processor configured to execute the instructions to perform operations comprising:
determining, based on a target vehicle being identified, a parking state of the target vehicle according to a vehicle type of the target vehicle and a parking position of the target vehicle,
controlling, based on the determined parking state indicating that the charging robot is capable of charging the target vehicle, a charging robot to charge the target vehicle, and
controlling, based on a state of charge (SOC) of the target vehicle, the charging robot to disconnect a connection between a charger and the target vehicle.

2. The control apparatus of claim 1, wherein the operation comprise:
receiving, from a closed-circuit television (CCTV) camera disposed at a position spaced apart from a position of the charging robot at a predetermined distance, a CCTV image for recognizing a target vehicle number, and
identifying the target vehicle among at least one vehicle included in the CCTV image.

3. The control apparatus of claim 2, wherein the operations comprise:
receiving, from a safety pillar module, a parking position of the target vehicle that is determined by a light detection and ranging (LiDAR) sensor of the safety pillar module installed at a position spaced apart from the position of the CCTV camera at a predetermined distance, and
determining, based on the position of the safety pillar module and the parking position of the target vehicle, a parking angle of the target vehicle and a parking distance between the target vehicle and the safety pillar module, to thereby determine the parking state of the target vehicle.

4. The control apparatus of claim 3, wherein determining the parking state comprises:
determining whether the parking angle is within a reference angle range including an angle range in which the charging robot is capable of charging the target vehicle,
determining whether the parking distance is within a reference distance range including a distance range in which the charging robot is capable of charging the target vehicle, and
determining, based on the parking angle being within in the reference angle range and the parking distance being within the reference distance range, that the parking state indicates that the charging robot is capable of charging the target vehicle.

5. The control apparatus of claim 4, wherein the operations further comprise:
providing, based on the parking angle being outside the reference angle range and the parking distance being outside the reference distance range, a notification to a driver, via an output device of the safety pillar module, to park the target vehicle again.

6. The control apparatus of claim 3, wherein the operations comprise:
receiving, from the safety pillar module, information about an end point of a side of the target vehicle, the end point at which the target vehicle and the safety pillar module are adjacent to each other,
determining a position of the end point based on an angle and a distance formed by the end point and the position of the safety pillar module,
applying the vehicle type of the target vehicle to a database to receive an absolute position of a charging port of the target vehicle, and
determining a relative position of the charging port with respect to the charging robot, based on the position of the end point and the absolute position of the charging port.

7. The control apparatus of claim 6, wherein the operations comprise:
controlling, based on a determination that the parking state indicates that the charging robot is capable of charging the target vehicle, the charging robot to move to a position of the charger.

8. The control apparatus of claim 7, wherein the operations comprise:
determining, based on the charging robot reaching the position of the charger, whether the charging robot and a charger cable of the charger are coupled to each other according to comparison between an input signal of a tool changer of the charging robot and a value of a force-torque (FT) sensor of the charging robot, and
controlling, based on the charging robot being failed to couple to the charger, the charging robot to attempt coupling to the charger cable of the charger a predetermined number of times.

9. The control apparatus of claim 8, wherein the operations comprise:
controlling, based on the charging robot succeeding to couple to the charger, the charging robot to move to a target position obtained according to a stroke in which motion of the charging robot to which the charger cable is coupled is drivable.

10. The control apparatus of claim 9, wherein the operations comprise:
recognizing, based on the charging robot moving to the target position along a rail, the charging port using a vision camera of the charging robot,
applying a predetermined offset to the relative position of the charging port to determine a position of a robot arm of the charging robot,
controlling the charging robot to charge the target vehicle based on the position of the robot arm, and
providing, based on the charging port not being recognized, a notification to a driver, via an output device of the safety pillar module, to park the target vehicle again.

11. A charging robot control method, comprising:
determining, based on a target vehicle being identified, a parking state of the target vehicle according to a vehicle type of the target vehicle and a parking position of the target vehicle,
controlling, based on the determined parking state indicating that a charging robot is capable of charging the target vehicle, a charging robot to charge the target vehicle, and
controlling, based on a state of charge (SOC) of the target vehicle, the charging robot to disconnect a connection between a charger and the target vehicle.

12. The charging robot control method of claim 11, wherein determining the parking state of the target vehicle comprises:
receiving, from a closed-circuit television (CCTV) camera disposed at a position spaced apart from a position of the charging robot at a predetermined distance, a CCTV image for recognizing a target vehicle number, and
identifying the target vehicle among at least one vehicle included in the CCTV image.

13. The charging robot control method of claim 12, wherein determining the parking state of the target vehicle comprises:
receiving, from a safety pillar module, a parking position of the target vehicle that is determined by a light detection and ranging (LiDAR) sensor of the safety pillar module installed at a position spaced apart from the position of the CCTV camera at a predetermined distance, and
determining, based on the position of the safety pillar module and the parking position of the target vehicle, a parking angle of the target vehicle and a parking distance between the target vehicle and the safety pillar module, to thereby determine the parking state of the target vehicle.

14. The charging robot control method of claim 13, wherein determining the parking state of the target vehicle comprises:
determining whether the parking angle is within a reference angle range including an angle range in which the charging robot is capable of charging the target vehicle,
determining whether the parking distance is within a reference distance range including a distance range in which the charging robot is capable of charging the target vehicle, and
determining, based on the parking angle being within the reference angle range and the parking distance being within the reference distance range, that the parking state indicates that the charging robot is capable of charging the target vehicle.

15. The charging robot control method of claim 14, wherein determining the parking state of the target vehicle comprises:
providing, based on the parking angle being outside the reference angle range and the parking distance being outside the reference distance range, a notification to a driver, via an output device of the safety pillar module, to park the target vehicle again.

16. The charging robot control method of claim 13, wherein determining the parking state of the target vehicle comprises:
receiving, from the safety pillar module, information about an end point of a side of the target vehicle, the end point at which the target vehicle and the safety pillar module are adjacent to each other,
determining a position of the end point, based on an angle and a distance formed by the end point and the position of the safety pillar module,
applying the vehicle type of the target vehicle to a database to receive an absolute position of a charging port of the target vehicle, and
determining a relative position of the charging port with respect to the charging robot, based on the position of the end point and the absolute position of the charging port.

17. The charging robot control method of claim 16, wherein controlling the charging robot to charge the target vehicle comprises:
controlling, based on a determination that the parking state indicates that the charging robot is capable of charging the target vehicle, the charging robot to move to a position of the charger.

18. The charging robot control method of claim 17, wherein controlling the charging robot to charge the target vehicle comprises:
determining, based on the charging robot reaching the position of the charger, whether the charging robot and a charger cable of the charger are coupled to each other according to comparison between an input signal of a tool changer of the charging robot and a value of a force-torque (FT) sensor of the charging robot, and
controlling, based on charging robot being failed to couple to the charger, the charging robot to attempt coupling to the charger cable of the charger a predetermined number of times.

19. The charging robot control method of claim 18, wherein controlling the charging robot to charge the target vehicle comprises:
controlling, based on the charging robot succeeding to couple to the charger, the charging robot to move to a target position obtained according to a stroke in which motion of the charging robot to which the charger cable is coupled is drivable.

20. The charging robot control method of claim 19, wherein controlling the charging robot to charge the target vehicle comprises:
recognizing, based on the charging robot moving to the target position along a rail, the charging port using a vision camera of the charging robot,
applying a predetermined offset to the relative position of the charging port to determine a position of a robot arm of the charging robot,
controlling the charging robot to charge the target vehicle based on the position of the robot arm, and
providing, based on the charging port not being recognized, a notification to a driver, via an output device of the safety pillar module, to park the target vehicle again.
